(19) United States
(12) Patent Application Publication
(10) Pub. No.: US 2025/0187866 A1
(43) Pub. Date: Jun. 12, 2025

(54) DOCUMENT TRANSPORT DEVICE

(71) Applicant: Sharp Kabushiki Kaisha, Sakai City (JP)

(72) Inventor: HIDEYUKI HIRO, Sakai City (JP)

(21) Appl. No.: 18/976,417

(22) Filed: Dec. 11, 2024

(30) Foreign Application Priority Data
Dec. 12, 2023 (JP) 2023-208902

(51) Int. Cl. B65H 43/00; B65H 1/14; B65H 3/06; B65H 5/06

(52) U.S. Cl. CPC B65H 43/00; B65H 1/14; B65H 3/06; B65H 5/06; B65H 2511/11; B65H 2511/12

(57) ABSTRACT

A document transport device comprises: a document feed roller that supplies a document to a transport path; a document feed tray on which the document is allowed to be placed; a size sensor that detects a size of the document on the document feed tray; a lifter that causes the document on the document feed tray to come into contact with the document feed roller by raising the document feed tray; and one or more controllers that control the lifter, based on a detection signal from the size sensor, wherein the one or more controllers control the lifter in such a way as to lower the document feed tray, in a case where the size sensor detects that a size of the document is about to be changed in a state where the document on the document feed tray is made contact with the document feed roller by the lifter.

### CROSS-REFERENCE TO RELATED APPLICATION

The present application claims priority from Japanese Application JP 2023-208902, the content to which is hereby incorporated by reference into this application.

### BACKGROUND OF THE INVENTION

### 1. Field of the Invention

The present disclosure relates to a document transport device.

### 2. Description of the Related Art

In recent years, development of a document transport device loaded in an image forming apparatus has been performed. In a document transport device as described above, generally, a document feed tray is raised or lowered based on a user's operation with respect to an operation panel.

### SUMMARY OF THE INVENTION

In a document transport device as described above, a document feed tray is raised by a user's operation with respect to a panel in a state where a document is placed on the document feed tray. There is a case where a user wishes to remove a document that has been placed on the document feed tray by mistake, after the document feed tray is raised. In this case, there occurs a problem that, if a user pulls out the document sandwiched between a document feed roller and the document feed tray, the document feed tray and the document may be damaged. This problem also occurs in a document transport device in which a document is sandwiched between a document feed roller and a document feed tray by lowering the document feed roller toward the document feed tray.

The present disclosure has been made in view of the above problem. An object of the present disclosure is to provide a document transport device capable of suppressing damage of a document feed roller and a document.

A document transport device according to a first aspect of the present disclosure includes a document feed roller that supplies a document to a transport path; a document feed tray on which the document is allowed to be placed; a size sensor that detects a size of the document on the document feed tray; a lifter that causes the document on the document feed tray to come into contact with the document feed roller by raising the document feed tray; and one or more controllers that control the lifter, based on a detection signal from the size sensor. The one or more controllers control the lifter in such a way as to lower the document feed tray, in a case where the size sensor detects that a size of the document is about to be changed in a state where the document on the document feed tray is made contact with the document feed roller by the lifter.

A document transport device according to a second aspect of the present disclosure includes a document feed roller that supplies a document to a transport path; a document feed tray on which the document is allowed to be placed; a size sensor that detects a size of the document on the document feed tray; a lifter that causes the document on the document feed tray to come into contact with the document feed roller by lowering the document feed roller; and one or more controllers that control the lifter, based on a detection signal from the size sensor. The one or more controllers control the lifter in such a way as to raise the document feed roller, in a case where the size sensor detects that a size of the document is about to be changed in a state where the document on the document feed tray is made contact with the document feed roller by the lifter.

### BRIEF DESCRIPTION OF THE DRAWINGS

FIG. 1 is a perspective view of a document transport device according to a first embodiment.

FIG. 2 is a perspective view illustrating a state in which a cover of the document transport device according to the first embodiment is opened.

FIG. 3 is a cross-sectional view of the document transport device according to the first embodiment.

FIG. 4 is a functional block diagram illustrating an overall configuration of the document transport device according to the first embodiment.

FIG. 5 is a schematic plan view of the document transport device according to the first embodiment, and is a diagram illustrating a state in which a user's hand is moving a guide member after a document feed tray is raised and before a document is supplied to a transport path by a document feed roller.

FIG. 6 is a schematic cross-sectional view of the document transport device according to the first embodiment, and is a diagram illustrating a state in which a document feed roller is supplying a document to the transport path after the document feed tray is raised.

FIG. 7 is a schematic plan view of the document transport device according to the first embodiment, and is a diagram illustrating a state in which a user's hand is moving the guide member.

FIG. 8 is a schematic cross-sectional view of the document transport device according to the first embodiment, and is a diagram illustrating a state in which transport of a document that has already been supplied to the transport path is completed by a plurality of transport rollers after the document feed roller is stopped.

FIG. 9 is a schematic cross-sectional view of the document transport device according to the first embodiment, and is a diagram illustrating a state in which a print job is stopped after the document feed tray is lowered.

FIG. 10 is a schematic cross-sectional view of the document transport device according to the first embodiment, and is a diagram illustrating a state in which presence of a user's hand is detected by a size sensor.

FIG. 11 is a schematic cross-sectional view of the document transport device according to the first embodiment, and is a diagram illustrating a state in which lifting of an end portion of a document by a user's hand is detected by the size sensor.

FIG. 12 is a first diagram of a first flowchart for explaining processing to be performed by a controller of the document transport device according to the first embodiment before transport of a document.

FIG. 13 is a second flowchart for explaining processing to be performed by the controller of the document transport device according to the first embodiment before transport of a document.

FIG. 14 is a third flowchart for explaining processing to be performed by the controller of the document transport device according to the first embodiment before transport of a document.

FIG. 15 is a flowchart for explaining processing to be performed by the controller of the document transport device according to the first embodiment during transport of a document.

FIG. 16 is a perspective view of a document transport device according to a second embodiment.

FIG. 17 is a perspective view illustrating a state in which a cover of the document transport device according to the second embodiment is opened.

FIG. 18 is a cross-sectional view of the document transport device according to the second embodiment.

FIG. 19 is a functional block diagram illustrating an overall configuration of the document transport device according to the second embodiment.

FIG. 20 is a schematic cross-sectional view of the document transport device according to the second embodiment, and is a diagram illustrating a state in which a document feed roller is away from a document on a document feed tray by raising a document feed roller.

FIG. 21 is a schematic cross-sectional view of the document transport device according to the second embodiment, and is a diagram illustrating a state in which a document is being supplied to a transporter by the document feed roller because the document feed roller is in contact with the document on the document feed tray by lowering the document feed roller.

FIG. 22 is a schematic cross-sectional view of the document transport device according to the second embodiment, and is a diagram illustrating a state in which transport of a document on the document feed tray is completed by the transporter.

FIG. 23 is a flowchart for explaining processing to be performed by a controller of the document transport device according to the second embodiment (also applicable to the first embodiment) during transport of a document.

FIG. 24 is a flowchart of another example for explaining processing to be performed by the controller of the document transport device according to the second embodiment during transport of a document.

### DETAILED DESCRIPTION OF THE INVENTION

In the following, a document transport device according to embodiments of the present disclosure is described with reference to the drawings. Note that, in the drawings, the same or equivalent element is denoted by the same reference sign, and overlapping description thereof is omitted.

### First Embodiment

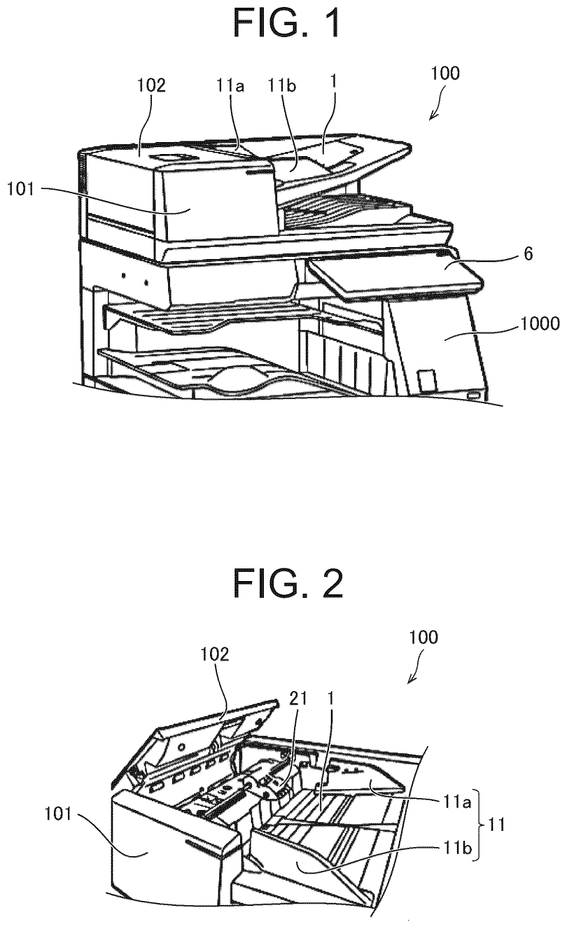

A document transport device 100 according to a first embodiment is described with reference to FIGS. 1 to 15. The document transport device 100 according to the present embodiment constitutes a part of an image forming apparatus.

FIG. 1 is a perspective view of the document transport device 100 according to the present embodiment. FIG. 2 is a perspective view illustrating a state in which a cover 102 of the document transport device 100 according to the present embodiment is opened.

As illustrated in FIGS. 1 and 2, the document transport device 100 is loaded on an image reading device (scanner) at an upper portion of an image forming apparatus main body 1000 including an operation acceptor 6 to be operated by a user to be openable with respect to the image forming apparatus main body 1000. The document transport device 100 includes a main body 101, and the cover 102 provided to be openable with respect to the main body 101. The operation acceptor 6 includes a touch panel and a switch operable by a user. The operation acceptor 6 allows the document transport device 100 to perform various functions described below.

It is understood that the document transport device 100 is provided in such a way that, when the cover 102 is opened with respect to the main body 101, a document feed tray 1 and a document feed roller 21 face to each other. In the present embodiment, the document feed tray 1 is configured in such a way as to move in an up-down direction, and the document feed roller 21 is fixed to the main body 101. Further, a guide portion 11 including a pair of guide members 11a and 11b that guide a document is provided on the document feed tray 1.

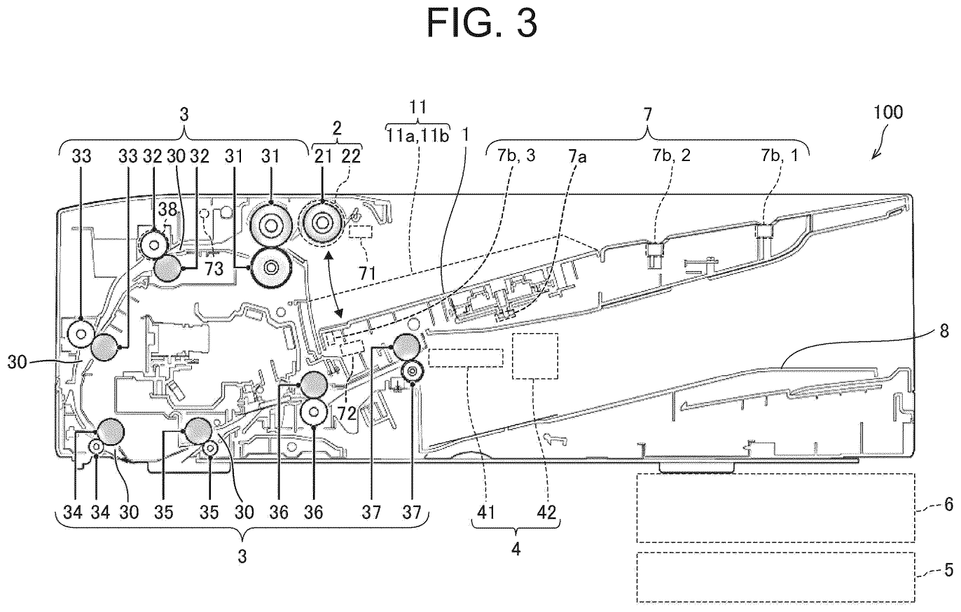

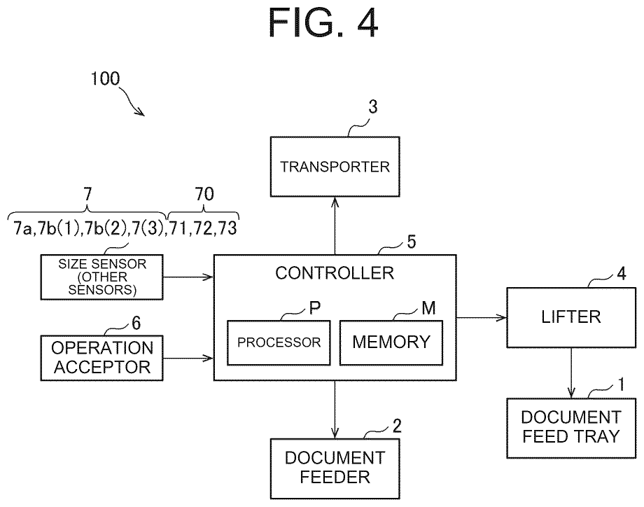

FIG. 3 is a cross-sectional view of the document transport device 100 according to the present embodiment. FIG. 4 is a functional block diagram illustrating an overall configuration of the document transport device 100 according to the present embodiment.

As illustrated in FIGS. 3 and 4, the document transport device 100 according to the present embodiment includes the document feed tray 1, a document feeder 2, a transporter 3, a lifter 4, a controller 5, the operation acceptor 6, a size sensor 7, a stacking tray 8, and the guide portion 11. The document transport device 100 according to the present embodiment includes, as sensors other than the size sensor 7, a document feed tray upper limit detection sensor 71, a document feed tray lower limit detection sensor 72, and a cover sensor 73.

The document feed tray 1 is configured in such a way that a document is allowed to be placed thereon. The document feed tray 1 is raised or lowered by the lifter 4 in a direction indicated by the arrow in FIG. 3. When the document feed tray 1 is raised by the lifter 4 in a state where a document is placed thereon, the document is brought into contact with the document feed roller 21. The document feed tray 1 is provided with the guide portion 11 and the size sensor 7.

The document feeder 2 includes the document feed roller 21 and a document feed motor 22. The document feed roller 21 is rotated by rotation of the document feed motor 22. The document feed motor 22 is rotated or stopped by being controlled by the controller 5. In a state where the document feed tray 1 is raised, the document feed tray 1 and the document feed roller 21 sandwich a document placed on the document feed tray 1. When the document feed motor 22 rotates the document feed roller 21 in this state, the document is supplied to a transport path 30 by the document feed roller 21.

The transporter 3 includes a plurality of transport rollers 31, 32, 33, 34, 35, 36, and 37. The transport path 30 is formed in such a way as to connect positions between each opposing rollers among the plurality of transport rollers 31, 32, 33, 34, 35, 36, and 37. When the document feed motor 22 is rotated, only the transport rollers 31 of the transporter 3 are rotated by transmission of rotation of the document feed motor 22 via a belt. Further, the transporter 3 includes, in addition to the transport rollers 31, a transport motor 38 that rotates each of the plurality of transport rollers 32, 33, 34, 35, 36, and 37. A specific transport roller among the plurality of transport rollers 32, 33, 34, 35, 36, and 37 receives rotational motion by the transport motor 38 directly or via a belt. A transport roller among the plurality of transport rollers 32, 33, 34, 35, 36, and 37 other than the specific transport roller is rotated following rotation of an opposing transport roller.

A document supplied to the transport rollers 31 that are rotated together with the document feed roller 21 by rotation of the document feed roller 21 is transported along the transport path 30 by rotation of each of the plurality of transport rollers 32, 33, 34, 35, 36, and 37 by driving of the transport motor 38. The document is fed out from the transport path 30 onto the stacking tray 8 after transported along the transport path 30.

The lifter 4 includes a lifting mechanism 41 and a lifting motor 42. The lifting mechanism 41 is configured in such a way as to raise or lower the document feed tray 1 in a direction indicated by the arrow. The lifting motor 42 is driven in such a way as to raise or lower the lifting mechanism 41 by being controlled the controller 5. In a case where the lifting mechanism 41 raises the document feed tray 1, a document placed on the document feed tray 1 comes into contact with the document feed roller 21. Consequently, the document placed on the document feed tray 1 is sandwiched between the document feed tray 1 and the document feed roller 21.

The controller 5 is called a controller. As illustrated in FIG. 4, the controller 5 includes a memory M, and a processor P that executes a program stored in the memory M. The processor P receives a command signal from the operation acceptor 6. Further, the processor P receives a detection signal from the size sensor 7 (7a, 7b(1), 7b(2), 7b(3)), and other sensors 70 (71, 72, 73). Thus, the processor P controls the document feed motor 22, the transport motor 38, the lifting motor 42, and the like, based on a command signal or a detection signal.

The operation acceptor 6 is a user interface generally called a touch panel. The operation acceptor 6 is configured, for example of a liquid crystal display panel. The operation acceptor 6 transmits a command signal to the controller 5 to be described later by touching an operation icon to be displayed on a liquid crystal display panel. For example, a user transmits, to the controller 5, a command signal capable of specifying a job related to printing by operating the operation acceptor 6.

The size sensor 7 includes the guide width detection sensor 7a, the document length sensors 7b(1) and 7b(2), and the document detection sensor 7b(3). The guide width detection sensor 7a is a sensor for detecting that a distance between the guide member 11a and the guide member 11b is changed by a predetermined value, for example, 10 mm or more. The document length sensors 7b(1) and 7b(2) are sensors for detecting a change in the length of a document placed on the document feed tray 1 in a traveling direction thereof. The document detection sensor 7b(3) is a sensor for detecting presence or absence of a document on the document feed tray 1 (whether the document length is 0 or not).

The other sensors 70 include the document feed tray upper limit detection sensor 71, the document feed tray lower limit detection sensor 72, and the cover sensor 73. The document feed tray upper limit detection sensor 71 detects that the document feed tray 1 is raised to an upper limit, and transmits a detection signal indicating the detection to the controller 5. The document feed tray lower limit detection sensor 72 detects that the document feed tray 1 is lowered to a lower limit, and transmits a detection signal indicating the detection to the controller 5. The cover sensor 73 detects that the cover 102 is opened, and transmits a detection signal indicating the detection to the controller 5.

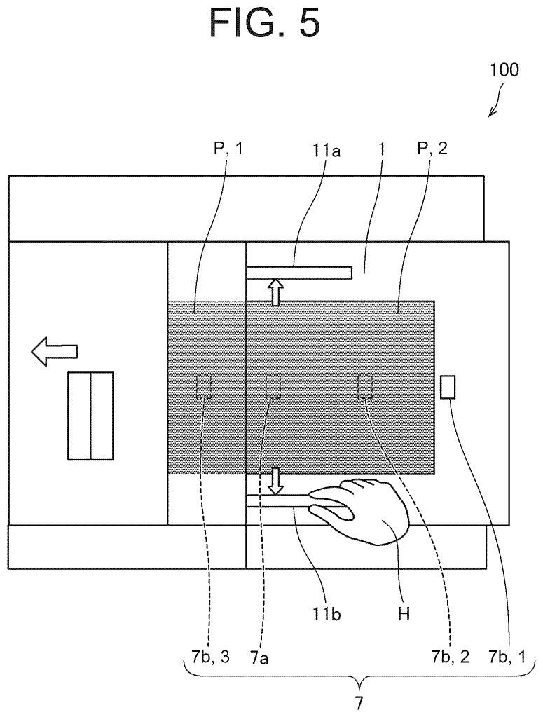

Next, a summary of a series of operations of the document transport device 100 according to the present embodiment is described with reference to FIGS. 5 to 9.

FIG. 5 is a schematic plan view of the document transport device 100 according to the present embodiment, and is a diagram illustrating a state in which a user's hand is moving the guide members 11a and 11b after the document feed tray 1 is raised, and before a document is supplied to a transport path by the document feed roller 21.

Before a document P(1) is supplied to the transport path 30 by rotation of the document feed roller 21, a user H may notice that the document P(1) is different from a document that should be supplied to the transport path 30. In this case, as illustrated in FIG. 5, the user H manually moves the pair of guide members 11a and 11b in a direction indicated by the white arrow in order to avoid supply of the document P(1) to the transport path 30 by the document feed roller 21.

Thus, when the guide width detection sensor 7a detects that the distance between the guide member 11a and the guide member 11b is changed by a predetermined amount or more, the guide width detection sensor 7a transmits a detection signal indicating the detection to the controller 5. Consequently, the controller 5 lowers the document feed tray 1.

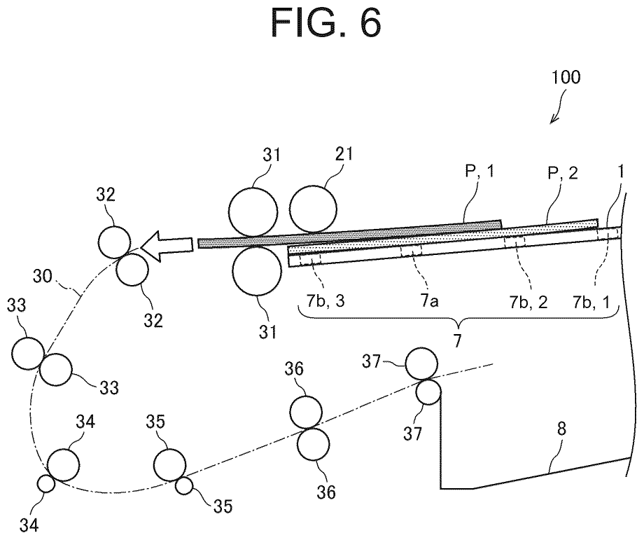

FIG. 6 is a schematic cross-sectional view of the document transport device 100 according to the present embodiment, and is a diagram illustrating a state in which the document feed roller 21 is supplying the document P(1) to the transport path 30 after the document feed tray 1 is raised.

As illustrated in FIG. 6, for example, two documents P(1) and P(2) are placed one over the other on the document feed tray 1. Thereafter, when the controller 5 receives a command signal for starting a print job from the operation acceptor 6 in response to a user's operation of the operation acceptor 6, the controller 5 causes the document transport device 100 to start transporting the documents P(1) and P(2). Note that, the command signal is not limited to a signal for starting a print job, and may be a command signal for any job.

In this case, first, the controller 5 drives the lifting motor 42 to cause the lifting mechanism 41 to raise the document feed tray 1. Thus, the document P(1) and the document P(2) are sandwiched between the document feed tray 1 and the document feed roller 21. At this occasion, the document P(1) placed on the upper side out of the documents P(1) and P(2) comes into contact with the document feed roller 21.

Thereafter, the controller 5 rotates each of the document feed motor 22 and the transport motor 38, whereby rotation of the document feed roller 21 and the transport rollers 31, 32, 33, 34, 35, 36, and 37 is started. Consequently, the document P(1) is supplied to the transport path 30 by rotation of the document feed roller 21. Thereafter, transport of the document P(1) in the transport path 30 is started by rotation of the transport rollers 31, 32, 33, 34, 35, 36, and 37.

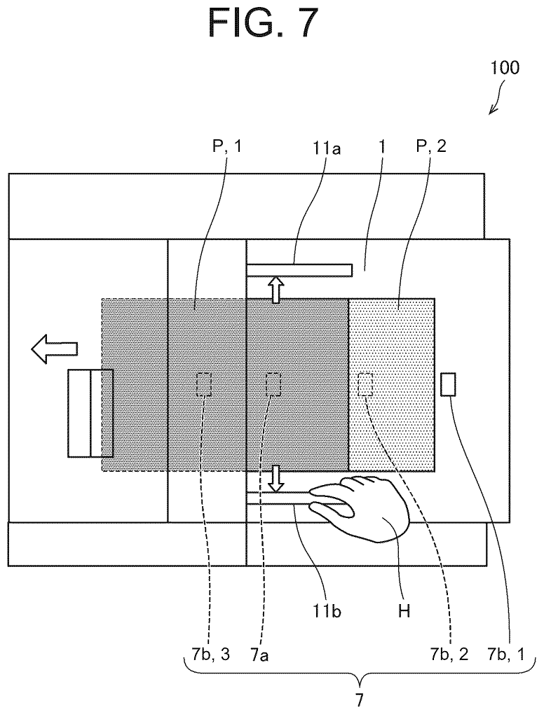

FIG. 7 is a schematic plan view of the document transport device 100 according to the present embodiment, and is a diagram illustrating a state in which the hand of the user His moving the guide members 11a and 11b.

As illustrated in FIG. 7, the document P(1) is supplied to the transport path 30 by rotation of the document feed roller 21. At this occasion, the user H may notice that the documents P(1) and P(2) actually being supplied to the transport path 30 are different from the documents that should be supplied to the transport path 30. In this case, the user H manually moves the pair of guide members 11a and 11b in a direction indicated by the white arrow in order to avoid further supply of the document P(2) to the transport path 30 by the document feed roller 21.

Thus, when the guide width detection sensor 7a detects that the distance between the guide member 11a and the guide member 11b is changed by a predetermined amount or more, the guide width detection sensor 7a transmits a detection signal indicating the detection to the controller 5. Consequently, the controller 5 causes the document feed motor 22 to stop rotation of the document feed roller 21. Thus, further supply of the document P(2) to the transport path 30 by the document feed roller 21 is not performed.

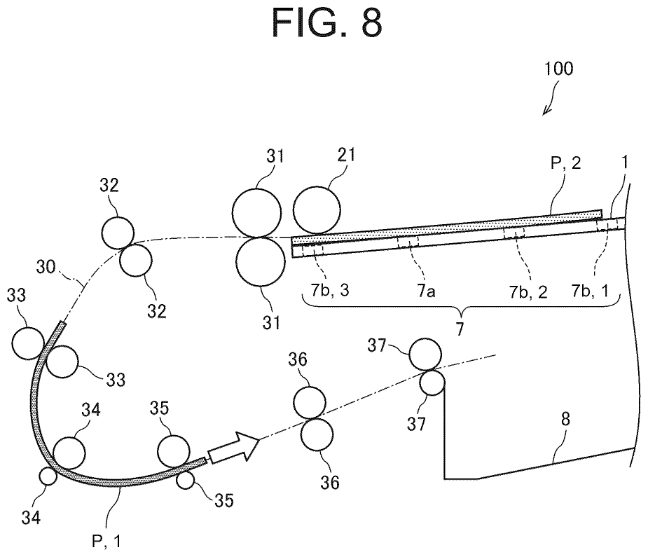

FIG. 8 is a schematic cross-sectional view of the document transport device 100 according to the present embodiment, and is a diagram illustrating a state in which transport of the document P(1) that has already been supplied to the transport path 30 is completed by the plurality of transport rollers 31, 32, 33, 34, 35, 36, and 37 after the document feed roller 21 is stopped.

As illustrated in FIG. 8, even when the guide width detection sensor 7a detects that the distance between the pair of guide members 11a and 11b is changed by a predetermined amount or more, the controller 5 continues rotating the transport motor 38. Thus, transport of the document P(1) by the plurality of transport rollers 32, 33, 34, 35, 36, and 37 is continued until the document P(1) that has already been supplied to the transport path 30 is fed out from the transport path 30 onto the stacking tray 8. However, at this occasion, the controller 5 has already stopped further supply of the document P(2) to the transport path 30 by the document feed roller 21 by stopping the document feed motor 22.

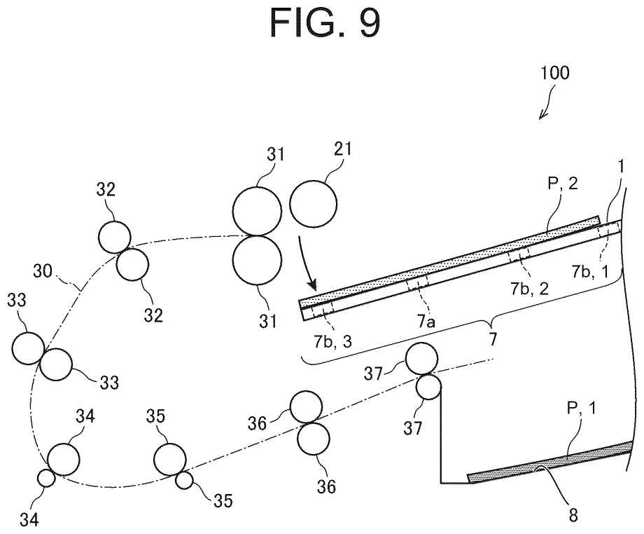

FIG. 9 is a schematic cross-sectional view of the document transport device 100 according to the first embodiment, and is a diagram illustrating a state in which a print job is stopped after the document feed tray 1 is lowered. Note that, the document transport device 100 may be configured in such a way that the document feed tray is lowered after a print job is stopped. Further, the job in this case is not limited to a print job, and may be any job.

As illustrated in FIG. 9, the document P(1) is fed out from the transport path 30 onto the stacking tray 8 by the plurality of transport rollers 31, 32, 33, 34, 35, 36, and 37. That is, even when the user H changes the distance between the pair of guide members 11a and 11b by a predetermined amount or more, transport of the document P(1) being transported is completed. Thereafter, the controller 5 drives the lifting motor 42 to cause the lifting mechanism 41 to lower the document feed tray 1, as indicated by the arrow. At this occasion, the document P(2) is placed on the document feed tray 1. Thereafter, the controller 5 completely stops the print job (the job may be a job other than the print job), based on a user's operation of the operation acceptor 6.

According to the above-described control of the controller 5, it is possible to prevent starting erroneous transport of a document P, while suppressing occurrence of a failure that the document P remains in the transport path 30. Consequently, even after the user notices erroneous supply of the document P to the transport path 30, it is possible to suppress occurrence of a failure that the document P is continued to be supplied to the transport path 30, while preventing jam of the document P in the transport path 30.

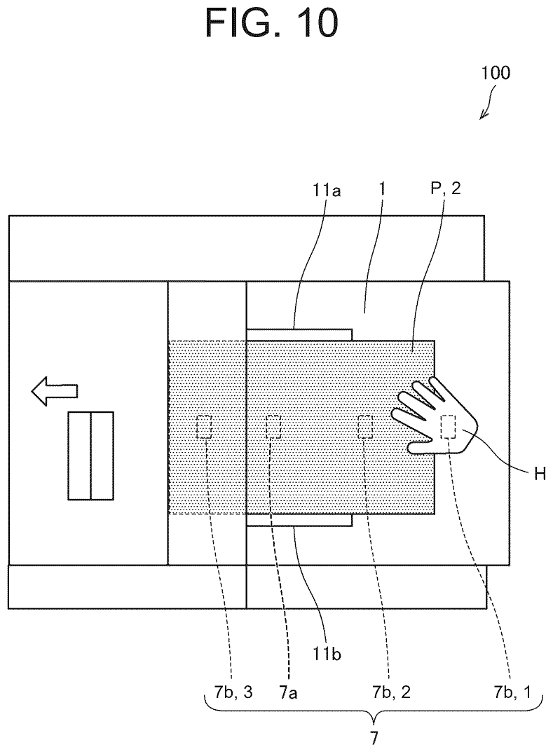

FIG. 10 is a schematic cross-sectional view of the document transport device 100 according to the present embodiment, and is a diagram illustrating a state in which presence of the hand of the user H is detected by the size sensor 7.

As illustrated in FIG. 10, a second example of the size sensor 7 is the document length sensor 7b(1) for detecting a length of the document P(2) in the traveling direction of the document P(2) placed on the document feed tray 1. In a state where the document P(2) on the document feed tray 1 is brought into contact with the document feed roller 21 by the lifter 4, the document length sensor 7b(1) may detect that the length of the document P(2) placed on the document feed tray 1 is increased. Also in this case, the controller 5 determines that the size sensor 7 has detected that the size of the document P(2) is about to be changed.

Specifically, the document length sensor 7b(1) may detect that the hand of the user H touches an end portion of the document P, for example, the document length sensor 7b(1) is turned on. In this case, the controller 5 determines that the size sensor 7 has detected that the size of the document P is about to be changed. Thus, in a case where the user's hand touches an end portion on a rear side of the document P(2) in the traveling direction, the document feed tray 1 can be automatically lowered.

Also in the case of the second example, the controller 5 lowers the document feed tray 1 by using the document length sensor 7b(1) generally used in the document transport device 100. Therefore, the number of components of the document transport device 100 does not increase.

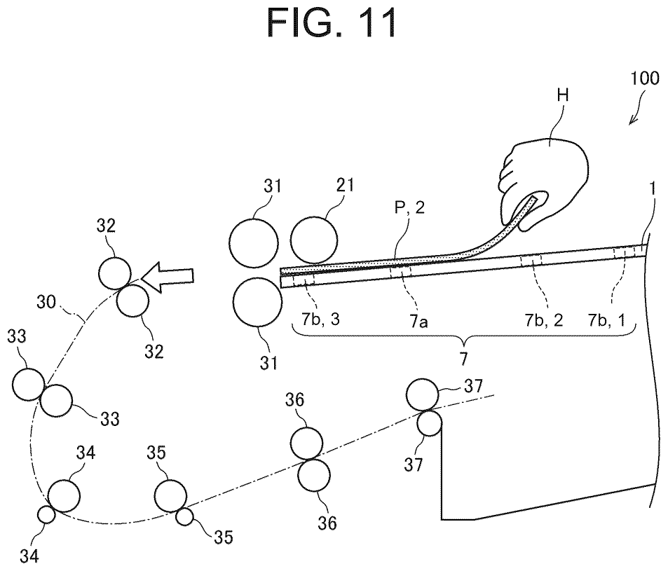

FIG. 11 is a schematic cross-sectional view of the document transport device 100 according to the present embodiment, and is a diagram illustrating a state in which the size sensor 7 detects that an end portion of the document P is lifted by the hand of the user H.

As illustrated in FIG. 11, a third example of the size sensor 7 is the document length sensor 7b(2) for detecting a length of the document P(2) in the traveling direction of the document P placed on the document feed tray 1. In the present embodiment, the document length sensor 7b(2) may detect that the length of the document P(2) placed on the document feed tray 1 is decreased in a state where the document P(2) on the document feed tray 1 is brought into contact with the document feed roller 21 by the lifter 4. Also in this case, the controller 5 determines that the size sensor 7 has detected that the size of the document P is about to be changed.

Specifically, the document length sensor 7b(2) may detect that the hand of the user His about to lift an end portion of the document P, for example, the document length sensor 7b(2) is turned off. In this case, the controller 5 determines that the size sensor 7 has detected that the size of the document P is about to be changed.

According to the document transport device 100 described above, the document feed tray 1 can be automatically lowered in a case where an end portion on the rear side of the document P in the traveling direction is lifted by a user.

Further, the controller 5 lowers the document feed tray 1 by using the document length sensor 7b(2) generally used in the document transport device 100. Therefore, the number of components of the document transport device 100 does not increase.

FIGS. 12 to 14 are first to third flowcharts each for explaining processing to be performed by the controller 5 of the document transport device 100 according to the present embodiment before transport of a document.

As illustrated in FIG. 12, in step S1, the controller 5 determines whether the cover 102 is closed based on a detection signal from the cover sensor 73. In step S1, in a case where it is determined that the cover 102 is not closed, in step S2, the controller 5 determines whether the cover 102 is changed to a closed state.

In step S2, in a case where it is determined that the cover 102 is not changed to a closed state, the controller 5 repeatedly performs pieces of processing of step S1 and step S2. On the other hand, in step S2, in a case where it is determined that the cover 102 is changed to a closed state, in step S3, the controller 5 performs processing of step S1 again after performing controlling of lowering the document feed tray 1.

In step S1, in a case where it is determined that the cover 102 is closed, in step S5, the controller 5 determines whether a document is placed on the document feed tray 1. In step S5, in a case where it is not determined that a document is placed on the document feed tray 1, the controller 5 performs processing of step S1. In step S5, in a case where it is determined that a document is placed on the document feed tray 1, in step S6, the controller 5 determines whether the document feed tray 1 is changed to a state in which a document is not placed thereon, based on a document detection signal by the document detection sensor 7b(3).

In step S6, in a case where it is determined that the document feed tray 1 is changed to a state in which a document is not placed, in step S3, the controller 5 performs processing of step S1 again after performing processing of causing the lifter 4 to lower the document feed tray 1. In step S6, it may be determined that the document feed tray 1 is not changed to a state in which a document is not placed thereon. In this case, in step S7, the controller 5 determines whether the document feed tray 1 is moved to an upper limit position, based on determination as to whether the document feed tray upper limit detection sensor 71 is turned on.

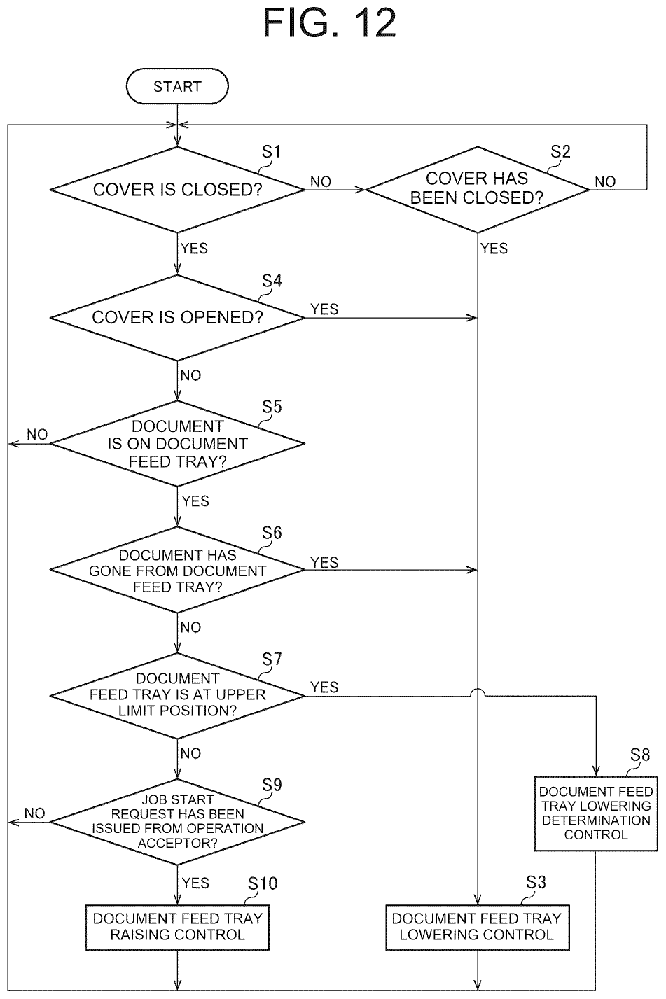

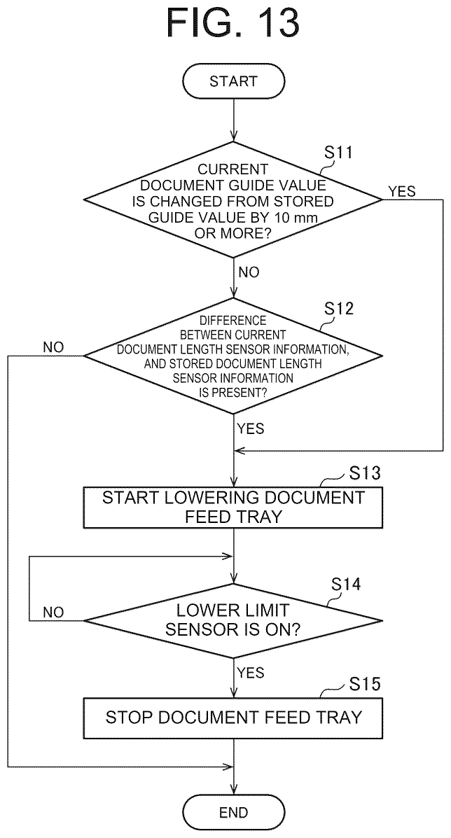

In step S7, it may be determined that the document feed tray 1 is moved to the upper limit position. In this case, in step S8, the controller 5 performs control of determining whether to lower the document feed tray 1 (document feed tray lowering determination control of S8 is steps S11 to S15 in FIG. 13). In step S7, it may be determined that the document feed tray 1 is not moved to the upper limit position. In this case, in step S9, the controller 5 determines whether a user's operation of starting a print job (the job may be a job other than a print job) on the operation acceptor 6 is performed, that is, whether a job start request signal is transmitted from the operation acceptor 6.

In step S9, in a case where it is determined that a job start request signal is not transmitted from the operation acceptor 6, the controller 5 performs processing of step S1 again. In step S9, in a case where it is determined that a job start request signal is transmitted from the operation acceptor 6, in step S10, the controller 5 causes to raise the document feed tray 1.

As illustrated in FIG. 13, in document feed tray lowering determination control of step S8 in FIG. 12, first, the controller 5 performs processing of step S11. In this case, the controller 5 receives a detection signal from the guide width detection sensor 7a. Thus, the controller 5 determines whether a current distance between the pair of guide members 11a and 11b is changed from a distance between the pair of guide members 11a and 11b stored in the memory M and previously detected by the guide width detection sensor 7a by a predetermined amount, for example, 10 mm or more.

In step S11, it may be determined that a current distance between the pair of guide members 11a and 11b is changed from a distance between the pair of guide members 11a and 11b stored in the memory M and previously detected by the guide width detection sensor 7a by a predetermined amount or more. In this case, in step S13, the controller 5 controls the lifter 4 in such a way as to lower the document feed tray 1.

Meanwhile, in step S11, it may be determined that a current distance between the pair of guide members 11a and 11b is not changed from a distance between the pair of guide members 11a and 11b stored in the memory M and previously detected by the guide width detection sensor 7a by a predetermined amount or more. In this case, in step S12, the controller 5 determines whether there is a difference between a current document length and a previous document length, regarding a document length in the traveling direction of the document according to a detection signal from the document length sensors 7b(1) and 7b(2).

In step S12, in a case where it is determined that there is a difference between a current document length and a previous document length, in step S13, the controller 5 causes the lifting mechanism 41 to lower the document feed tray 1 by driving the lifting motor 42. On the other hand, in step S12, in a case where it is determined that there is no difference between a current document length and a previous document length, the controller 5 repeats pieces of processing of steps S11 and S12.

In step S14, the controller 5 determines whether the document feed tray 1 is moved to a lower limit position, based on determination as to whether the document feed tray lower limit detection sensor 72 is turned on. In step S14, in a case where it is determined that the document feed tray 1 is not moved to the lower limit position, the controller 5 repeats processing of step S14 until the document feed tray 1 is moved to the lower limit position. In step S14, in a case where it is determined that the document feed tray 1 is moved to the lower limit position, in step S15, the controller 5 controls the lifter 4 in such a way as to stop lowering the document feed tray 1.

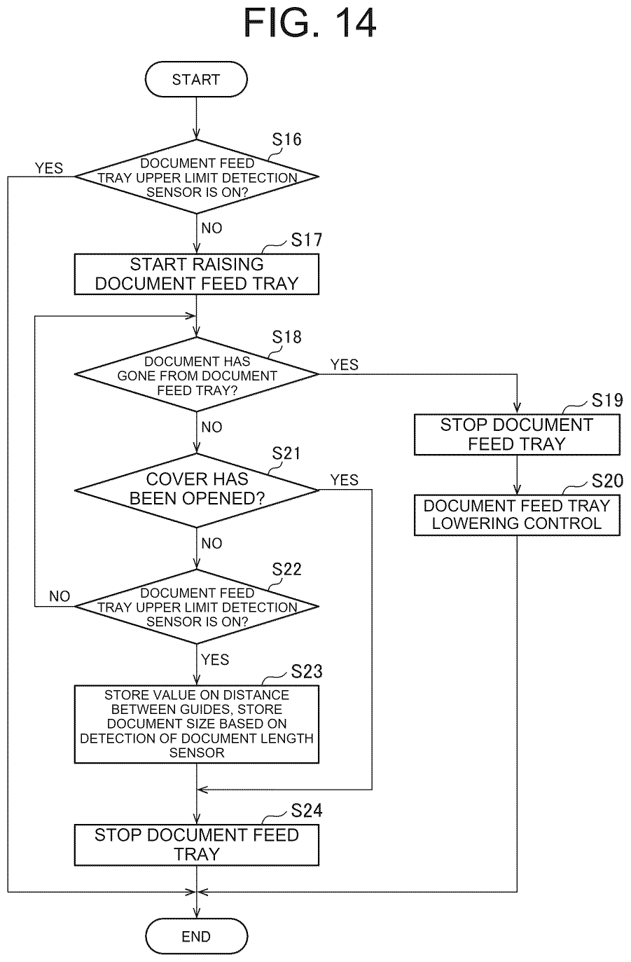

As illustrated in FIG. 14, in step S16, it is determined whether the document feed tray 1 is moved to the upper limit position, based on determination as to whether the document feed tray upper limit detection sensor 71 is turned on. In step S16, in a case where it is determined that the document feed tray 1 is moved to the upper limit position, the controller 5 performs processing of step S16 again. In step S16, in a case where it is determined that the document feed tray 1 is not moved to the upper limit position, in step S17, the controller 5 controls the lifter 4 in such a way as to raise the document feed tray 1.

In step S18, it is determined whether the document feed tray 1 is changed to a state in which a document is not placed thereon, based on determination as to whether the document detection sensor 7b(3) is turned on. In step S18, in a case where it is determined that the document feed tray 1 is changed to a state in which a document is not placed thereon, in step S19, the controller 5 stops control of causing the lifter 4 to raise the document feed tray 1. Thereafter, in step S20, the controller 5 performs control of causing the lifter 4 to lower the document feed tray 1. In step S18, in a case where it is determined that the document feed tray 1 is not changed to a state in which a document is not placed thereon, in step S21, the controller 5 determines whether the cover 102 is changed to an opened state, based on determination as to whether the cover sensor 73 is turned on.

In step S21, in a case where it is determined that the cover 102 is changed to an opened state, in step S24, the controller 5 controls the lifter 4 in such a way as to stop raising the document feed tray 1. In step S21, in a case where it is determined that the cover 102 is not changed to an opened state, in step S22, the controller 5 determines whether the document feed tray 1 is moved to the upper limit position, based on determination as to whether the document feed tray upper limit detection sensor 71 is turned on.

In step S22, in a case where it is determined that the document feed tray 1 is not moved to the upper limit position, the controller 5 repeatedly performs pieces of processing from step S18 to step S22. In step S22, it may be determined that the document feed tray 1 is moved to the upper limit position. In this case, in step S23, the controller 5 causes the memory M to store a value of a current distance between the pair of guide members 11a and 11b, based on a detection signal from the guide width detection sensor 7a, and a size of the document based on detection of the document length sensors 7b(1) and 7b(2). Thereafter, in step S24, the controller 5 performs processing of step S1 again after stopping control of raising the document feed tray 1 in step S19.

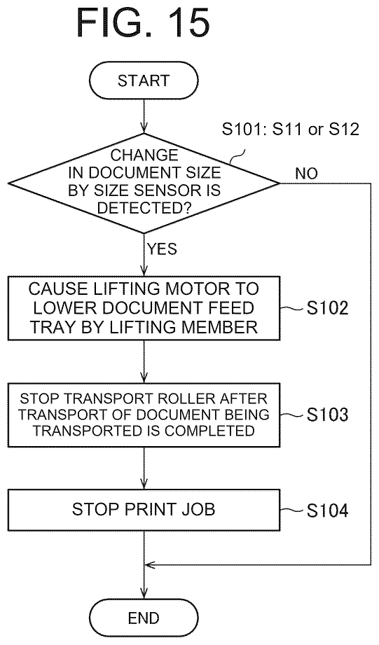

FIG. 15 is a flowchart for explaining processing to be performed by the controller 5 of the document transport device 100 according to the present embodiment during transport of a document.

As illustrated in FIG. 15, in step S101 (as with the case of S11 or S12 in FIG. 13), the controller 5 determines whether the size sensor 7 has detected that a size of the document is changed. As described above, the size sensor 7 is the guide width detection sensor 7a, the document length sensor 7b(1), and the document length sensor 7b(2). Therefore, the controller 5 determines that a size of the document is changed by turning on or off of any of the guide width detection sensor 7a, the document length sensor 7b(1), or the document length sensor 7b(2).

Thereafter, in step S102, in a case where it is determined that a change in the size of the document P is detected, in step S102, the controller 5 controls the lifting motor 42 of the lifter 4 in such a way as to lower the document feed tray 1 by the lifter 4. This point is similar to processing to be performed by the controller 5 before transport of a document, which is described with reference to FIGS. 12 to 14.

Thereafter, in step S103, after completing transport of the document P being transported by the plurality of transport rollers 31, 32, 33, 34, 35, 36, and 37, the controller 5 stops rotation of the plurality of transport rollers 31, 32, 33, 34, 35, 36, and 37. Next, in step S104, the controller 5 finishes the print job executed based on the above-described program.

However, after the document being transported in the transport path 30 is discharged onto the stacking tray 8, the controller 5 may stop rotation of the plurality of transport rollers 31, 32, 33, 34, 35, 36, and 37, and then lower the document feed tray 1. Further, the document transport device 100 may be configured in such a way that the document feed tray is lowered after a print job is stopped. Further, the job is not limited to a print job, and may be any job.

### Second Embodiment

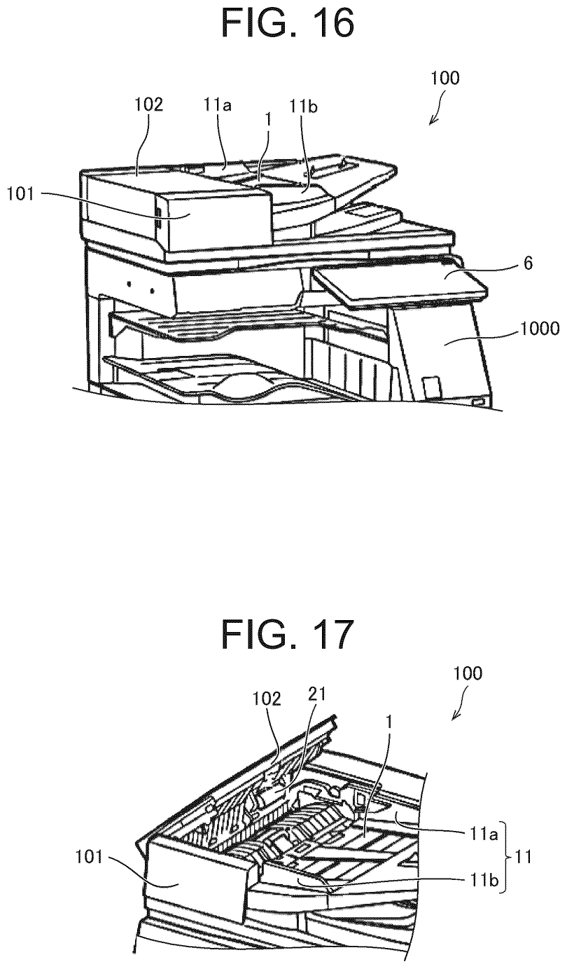

A document transport device 100 according to a second embodiment is described with reference to FIGS. 16 to 24. Note that, in the following, description on a point similar to the document transport device 100 according to the first embodiment is omitted. The document transport device 100 according to the present embodiment is different from the document transport device 100 according to the first embodiment in the following point.

FIG. 16 is a perspective view of the document transport device 100 according to the present embodiment. FIG. 17 is a perspective view illustrating a state in which a cover 102 of the document transport device 100 according to the present embodiment is opened.

As illustrated in FIGS. 16 and 17, in the present embodiment, it is understood that the document transport device 100 is provided in such a way that, when the cover 102 is opened with respect to a main body 101, a document feed roller 21 and a document feed tray 1 face to each other. In the present embodiment, the document feed roller 21 is configured to be movable up and down, and the document feed tray 1 has its position fixed.

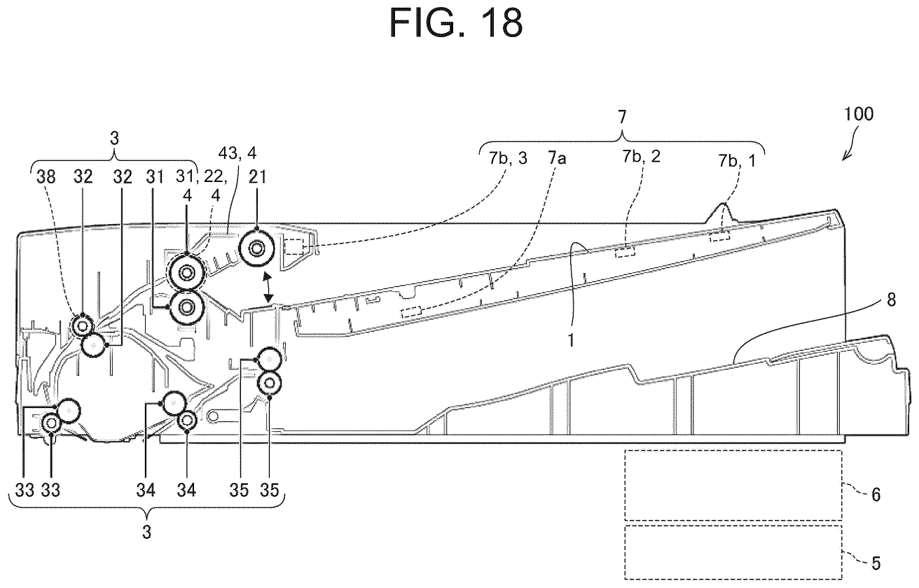

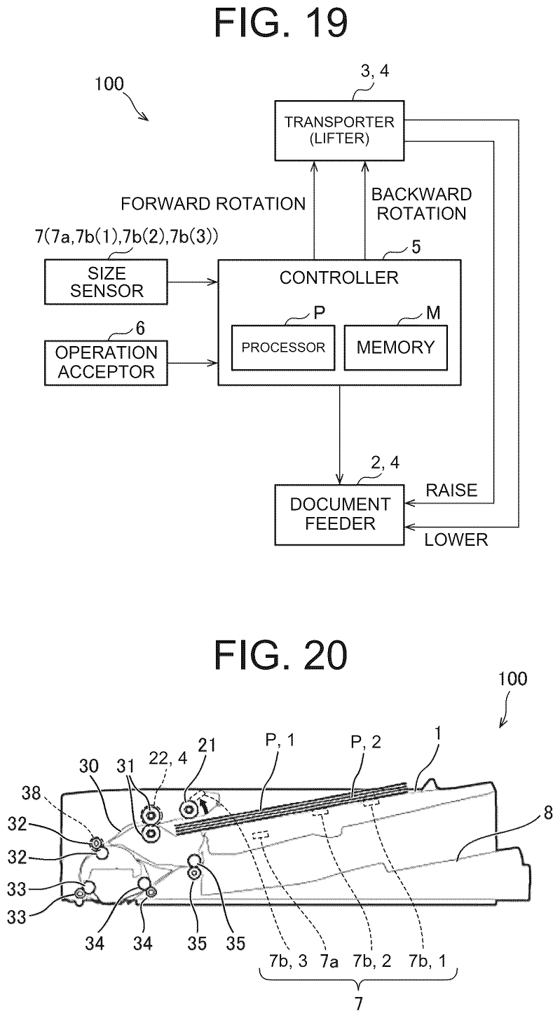

FIG. 18 is a cross-sectional view of the document transport device 100 according to the present embodiment. FIG. 19 is a functional block diagram illustrating an overall configuration of the document transport device 100 according to the present embodiment.

The document feed roller 21 is made contact with a document P on the document feed tray 1 by lowering the document feed roller 21 by a lifter 4 (a document feed motor 22, a transport roller 31, and a lifting member 43) of the present embodiment. Further, in the present embodiment, a plurality of transport rollers 32, 33, 34, and 35 are provided in place of the plurality of transport rollers 32, 33, 34, 35, 36, and 37 in the first embodiment. When the document feed motor 22 is rotated, the transport roller 31 is rotated. Along with this, the lifting member 43 is moved up and down. Rotation of the document feed motor 22 is transmitted to the document feed roller 21 via a belt. Therefore, the transport roller 31 and the document feed roller 21 are rotated in the same direction.

Note that, as with the case of the first embodiment, the document transport device 100 according to the present embodiment includes, in addition to the document feed motor 22, a transport motor 38 that rotates the plurality of transport rollers 32, 33, 34, and 35. As with the case of the first embodiment, when the transport motor 38 rotates the transport rollers 32, rotation of the transport rollers 32 is transmitted by rotation of a belt, and the plurality of transport rollers 33, 34, and 35 are rotated, whereby a document is transported in a transport path 30.

Specifically, when the document feed motor 22 (lifter 4) is rotated forward (clockwise in FIG. 18), the transport roller 31 (lifter 4) is rotated forward. Thus, the lifting member 43 (lifter 4) is rotated forward around a center axis of rotation of the transport roller 31. At this occasion, the document feed roller 21 mounted to a distal end of the lifting member 43 is rotated forward (lowered) around the center axis of rotation of the transport roller 31 in a direction indicated by the arrow in FIG. 18. Therefore, the document feed roller 21 approaches the document feed tray 1. Consequently, the document is sandwiched between the document feed tray 1 and the document feed roller 21.

On the other hand, when the document feed motor 22 (lifter 4) is rotated backward, the transport roller 31 (lifter 4) is rotated backward (counterclockwise in FIG. 18). Thus, the lifting member 43 (lifter 4) is rotated backward around the center axis of rotation of the transport roller 31. At this occasion, the document feed roller 21 mounted to a distal end of the lifting member 43 is rotated backward (raised) around the center axis of rotation of the transport roller 31 in a direction indicated by the arrow in FIG. 18. Therefore, the document feed roller 21 is moved away from the document feed tray 1. Consequently, the document feed roller 21 does not come into contact with the document on the document feed tray 1.

Therefore, the transport roller 31 and the lifting member 43 have a function similar to the lifting mechanism 41 of the first embodiment, and the document feed motor 22 has a function similar to the lifting motor 42 of the first embodiment. However, the document feed motor 22 and the transport roller 31 of the present embodiment also have a function similar to the document feed motor 22 and the transport roller 31 of the first embodiment. That is, the document feed motor 22 and the transport roller 31 of the present embodiment functions as both of the document feeder 2 and the lifter 4 of the first embodiment.

A controller 5 of the document transport device 100 according to the present embodiment performs control of raising or lowering a document feeder 2 (document feed roller 21) in place of the document feed tray 1 by controlling the document feed motor 22 that rotates the transport rollers 31. Note that, as described above, since the document feed tray 1 according to the present embodiment has its position fixed, the document feed tray 1 is not movable.

FIG. 20 is a schematic cross-sectional view of the document transport device 100 according to the present embodiment, and is a diagram illustrating a state in which the document feed roller 21 is away from a document P(1) on the document feed tray 1 by raising the document feed roller 21.

As illustrated in FIG. 20, when the controller 5 rotates the document feed motor 22 backward, the transport roller 31 is rotated backward, whereby the document feed roller 21 is raised. Consequently, as illustrated by the arrow in FIG. 20, the document feed roller 21 is raised, and moved away from the document P on the document feed tray 1.

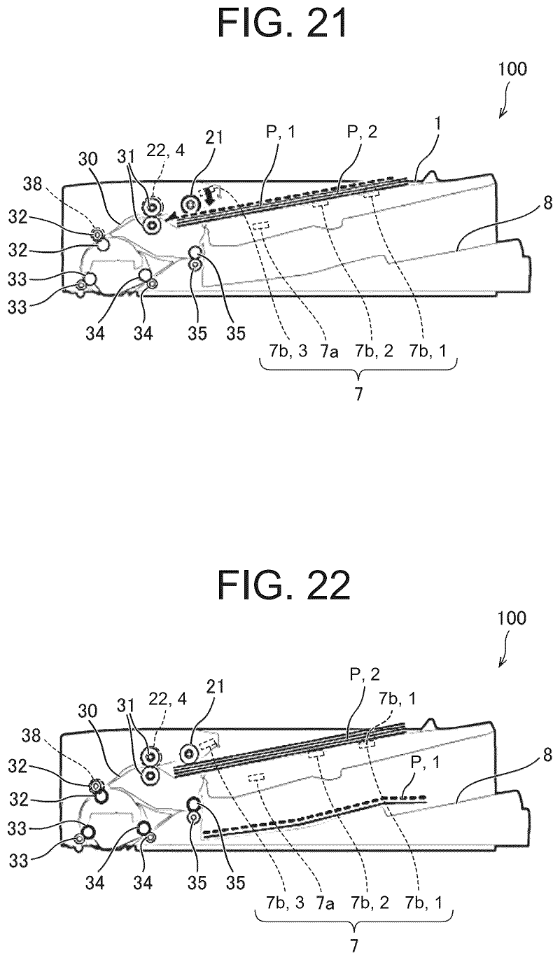

FIG. 21 is a schematic cross-sectional view of the document transport device 100 according to the present embodiment, and is a diagram illustrating a state in which the document P(1) is being supplied to a transporter 3 by the document feed roller 21, because the document feed roller 21 is in contact with the document P(1) on the document feed tray 1 by lowering the document feed roller 21.

As illustrated in FIG. 21, when the controller 5 rotates the document feed motor 22 forward, the transport roller 31 is rotated forward, whereby the document feed roller 21 is lowered. Consequently, as illustrated by the arrow in FIG. 21, the document feed roller 21 is lowered, and comes into contact with the document P(1) on the document feed tray 1.

FIG. 22 is a schematic cross-sectional view of the document transport device 100 according to the present embodiment, and is a diagram illustrating a state in which transport of the document P(1) on the document feed tray 1 by the transporter 3 is completed.

As illustrated in FIG. 22, in a case where a size sensor 7 (guide width detection sensor 7a) detects a change in the size of the document during transport of the document P(1), the controller 5 performs control of rotating the document feed motor 22 backward. Thus, the document feed roller 21 is moved away from the document feed tray 1. Consequently, supply of a document P(2) placed on the document feed tray 1 to the transport path 30 is not performed. Note that, in a case where the size sensor 7 (guide width detection sensor 7a) detects a change in the size of the document during transport of the document, the controller 5 stops rotation of the document feed motor 22. However, even in a case where the size sensor 7 (guide width detection sensor 7a) detects a change in the size of the document during transport of the document P(1), the controller 5 continues transport by the transporter 3 until transport of the document P(1) on the document feed tray 1 by the transporter 3 is completed.

As illustrated in FIGS. 21 and 22, the controller 5 lowers or raises the document feed roller 21 in place of the document feed tray 1 by selecting one of forward rotation and backward rotation of the document feed motor 22 which also functions as a lifting motor. Thus, the document feed roller 21 comes into contact with the document P on the document feed tray 1, or is moved away from the document P on the document feed tray 1.

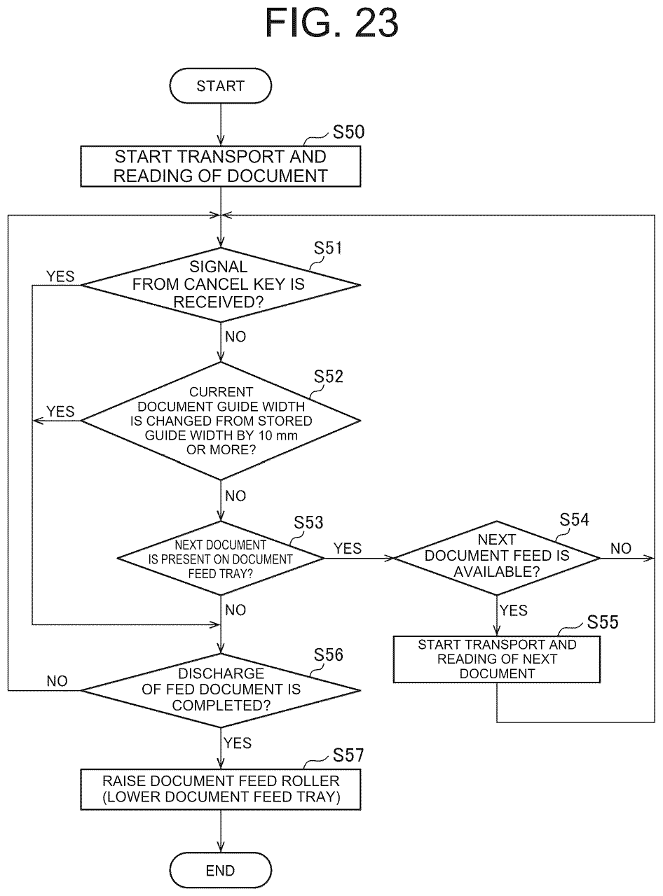

FIG. 23 is a flowchart for explaining processing to be performed by the controller 5 of the document transport device 100 according to the present embodiment (applicable to the first embodiment) during transport of a document.

As illustrated in FIG. 23, in step S50, the controller 5 causes the document feed roller 21 to supply the document P to the transport path 30 by rotating the document feed motor 22 forward. Thus, transport by the transport rollers 31, 32, 33, 34, and 35 is started. Consequently, reading of the document by a document reading device is started. In step S51, the controller 5 determines whether a signal indicting cancellation of a print job (may be a job other than a print job) is received from an operation acceptor 6. In step S51, in a case where it is determined that a signal indicating cancellation of a print job is received, the controller 5 performs processing of step S56.

In step S51, it may not be determined that a signal indicating cancellation of a print job (may be a job other than a print jot) is received. In this case, in step S52, the controller 5 receives a detection signal received from the guide width detection sensor 7a. Thus, the controller 5 determines whether a current distance between a pair of guide members 11a and 11b is changed from a distance between the pair of guide members 11a and 11b stored in a memory M and previously detected by the guide width detection sensor 7a by a predetermined distance, for example, 10 mm or more.

In step S52, it may be determined that the current distance between the pair of guide members 11a and 11b is changed from the distance between the pair of guide members 11a and 11b stored in the memory M and previously detected by the guide width detection sensor 7a by a predetermined amount or more. In this case, processing of step S56 is performed.

In step S52, it may not be determined that the current distance between the pair of guide members 11a and 11b is changed from the distance between the pair of guide members 11a and 11b stored in the memory M and previously detected by the guide width detection sensor by the predetermined amount or more. In this case, processing of step S53 is performed.

In step S53, the controller 5 determines whether a next document is placed on the document feed tray 1, based on a detection signal from a document detection sensor 7b(3). In step S53, in a case where it is determined that a next document is placed on the document feed tray 1, in step S54, the controller 5 determines whether feeding of the next document is available.

In step S54, in a case where it is determined that feeding of the next document is available, in step S55, the controller 5 performs processing of step S51 after starting transport and reading of the next document.

In step S53, it may not be determined that a next document is not placed on the document feed tray 1. In this case, in step S56, the controller 5 determines whether transport of a document P supplied to the transport path 30 by the document feed roller 21 is completed by the transport rollers 31, 32, 33, 34, and 35.

In step S56, in a case where it is not determined that transport of the document P supplied to the transport path 30 by the document feed roller 21 is completed by the transport rollers 31, 32, 33, 34, and 35, the controller 5 repeats pieces of processing from step S51 to step S56. In step S56, it may be determined that transport of the document supplied to the transport path 30 by the document feed roller 21 is completed by the transport rollers 31, 32, 33, 34, and 35. In this case, in step S57, the controller 5 controls the lifter 4 (document feed motor 22) in such a way as to raise the document feed roller 21. The lifter 4 according to the present embodiment is constituted of the document feed motor 22, the transport roller 31, and the lifting member 43. Therefore, the controller 5 rotates the transport roller 31 backward by rotating the document feed motor 22 backward. Thus, the document feed roller 21 provided at a distal end of the lifting member 43 is raised in such a way to be away from the document feed tray 1 by raising a distal end of the lifting member 43.

Also by the control of the controller 5 of the document transport device 100 according to the present embodiment described above, it is possible to easily and reliably stop erroneous transport of a document, while preventing paper jam and damage of the document feed roller 21 in the document transport device 100.

Processing to be performed by the controller 5 of the document transport device 100 according to the present embodiment illustrated in FIG. 23 can also be applied as processing to be performed by the controller 5 of the document transport device 100 according to the first embodiment. In this case, in step S57, the document feed tray 1 is lowered, in place of raising the document feed roller 21. Specifically, in a case of the document transport device 100 described in the first embodiment, in step S57, the controller 5 controls the lifter 4 (lifting motor 42) in such a way as to lower the document feed tray 1.

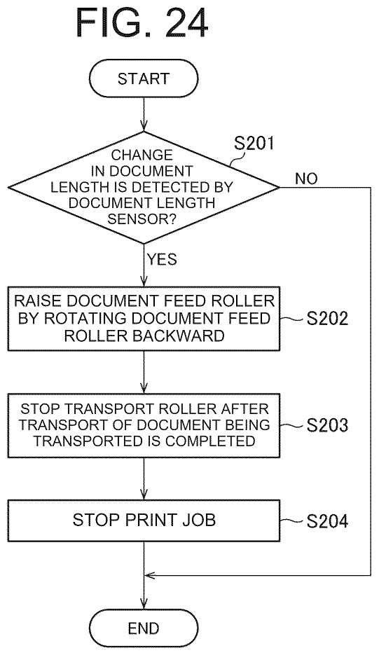

FIG. 24 is a flowchart of another example for explaining processing to be performed by the controller 5 of the document transport device 100 according to the present embodiment during transport of a document. The controller 5 of the document transport device 100 according to the present embodiment may perform processing illustrated in FIG. 24, in place of processing illustrated in FIG. 23.

As illustrated in FIG. 24, in another example of processing, in step S201, the controller 5 determines whether a document length sensor 7b(1) or 7b(2) has detected that a length of a document is changed. In step S202, in a case where it is determined that a change in the length of the document is detected, in step S202, the controller 5 rotates the document feed motor 22 (lifter 4) backward in such a way as to raise the document feed roller 21. However, the controller 5 continues transport by the transport rollers 32, 33, 34, and 35 by rotating the transport motor 38 until the document is fed out from the transport path 30 onto a document discharge tray 8.

The above control is described specifically as follows.

The document length sensor 7b(2) may detect that the length of the document P on the document feed tray 1 is decreased in a state where the lifter 4 (the document feed motor 22, the transport roller 31, and the lifting member 43) brings the document feed roller 21 into contact with the document P on the document feed tray 1. In this case, the controller 5 controls the lifter 4 (the transport motor 38, the transport roller 31, and the lifting member 43) in such a way as to raise the document feed roller 21. In addition, the document length sensor 7b(1) may detect that the length of the document P on the document feed tray 1 is increased in a state where the document feed motor 22 brings the document feed roller 21 into contact with the document P on the document feed tray 1. In this case, the controller 5 controls the lifter 4 (the document feed motor 22, the transport roller 31, and the lifting member 43) in such a way as to raise the document feed roller 21.

Thereafter, in step S203, after transport of the document P being transported by the plurality of transport rollers 31, 32, 33, 34, and 35 is completed, the controller 5 stops rotation of the plurality of transport rollers 31, 32, 33, 34, and 35. Next, in step S204, the controller 5 finishes a print job (may be a job other than a print job) that has been executed based on the above-described program.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A document transport device comprising:
a document feed roller that supplies a document to a transport path;
a document feed tray on which the document is allowed to be placed;
a size sensor that detects a size of the document on the document feed tray;
a lifter that causes the document on the document feed tray to come into contact with the document feed roller by raising the document feed tray; and
one or more controllers that control the lifter, based on a detection signal from the size sensor, wherein
the one or more controllers control the lifter in such a way as to lower the document feed tray, in a case where the size sensor detects that a size of the document is about to be changed in a state where the document on the document feed tray is made contact with the document feed roller by the lifter.

2. The document transport device according to claim 1, wherein
the document feed tray is configured in such a way as to guide the document from the document feed tray to the transport path, and includes a pair of guide members movable in accordance with a size of the document,
the size sensor is a guide width detection sensor that detects that a distance between the pair of guide members is changed by a predetermined amount or more, and
the one or more controllers control the lifter in such a way as to lower the document feed tray, in a case where the guide width detection sensor detects that a distance between the pair of guide members is changed by a predetermined amount or more in a state where the document on the document feed tray is made contact with the document feed roller by the lifter.

3. The document transport device according to claim 1, wherein
the size sensor is a document length sensor that detects a length of the document in a traveling direction of the document on the document feed tray, and
the one or more controllers control the lifter in such a way as to lower the document feed tray, in a case where the document length sensor detects that a length of the document on the document feed tray is decreased in a state where the document on the document feed tray is made contact with the document feed roller by the lifter.

4. The document transport device according to claim 1, wherein
the size sensor is a document length sensor that detects a length of the document in a traveling direction of the document on the document feed tray, and
the one or more controllers control the lifter in such a way as to lower the document feed tray, in a case where the document length sensor detects that a length of the document on the document feed tray is increased in a state where the document on the document feed tray is made contact with the document feed roller by the lifter.

5. The document transport device according to claim 1, further comprising:
a plurality of transport rollers that transport the document along the transport path, wherein
the one or more controllers control the plurality of transport rollers in such a way as to complete transport of the document for which transport by the plurality of transport rollers has already started, in a case where the size sensor detects that a size of the document is about to be changed.

6. The document transport device according to claim 1, wherein
the one or more controllers control the document feed roller in such a way as to stop further supply of the document on the document feed tray to the transport path by the document feed roller, in a case where the size sensor detects that a size of the document is about to be changed.

7. The document transport device according to claim 1, further comprising:
an operation acceptor that transmits, to the one or more controllers, a command signal capable of specifying a job, based on a user's operation, wherein
the one or more controllers stop execution of the job specified by the command signal received from the operation acceptor, in a case where the size sensor detects that a size of the document is about to be changed.

8. A document transport device comprising:
a document feed roller that supplies a document to a transport path;
a document feed tray on which the document is allowed to be placed;
a size sensor that detects a size of the document on the document feed tray;
a lifter that causes the document on the document feed tray to come into contact with the document feed roller by lowering the document feed roller; and
one or more controllers that control the lifter, based on a detection signal from the size sensor, wherein
the one or more controllers control the lifter in such a way as to raise the document feed roller, in a case where the size sensor detects that a size of the document is about to be changed in a state where the document on the document feed tray is made contact with the document feed roller by the lifter.

9. The document transport device according to claim 8, wherein
the document feed tray is configured in such a way as to guide the document from the document feed tray to the transport path, and includes a pair of guide members movable in accordance with a size of the document,
the size sensor is a guide width detection sensor that detects that a distance between the pair of guide members is changed by a predetermined amount or more, and
the one or more controllers control the lifter in such a way as to raise the document feed roller, in a case where the guide width detection sensor detects that a distance between the pair of guide members is changed by a predetermined amount or more in a state where the document on the document feed tray is made contact with the document feed roller by the lifter.

10. The document transport device according to claim 8, wherein
the size sensor is a document length sensor that detects a length of the document in a traveling direction of the document on the document feed tray, and
the one or more controllers control the lifter in such a way as to raise the document feed roller, in a case where the document length sensor detects that a length of the document on the document feed tray is decreased in a state where the document on the document feed tray is made contact with the document feed roller by the lifter.

11. The document transport device according to claim 8, wherein
the size sensor is a document length sensor that detects a length of the document in a traveling direction of the document on the document feed tray, and
the one or more controllers control the lifter in such a way as to raise the document feed roller, in a case where the document length sensor detects that a length of the document on the document feed tray is increased in a state where the document on the document feed tray is made contact with the document feed roller by the lifter.

12. The document transport device according to claim 8, further comprising
a plurality of transport rollers that transport the document along the transport path, wherein
the one or more controllers control the plurality of transport rollers in such a way as to complete transport of the document for which transport by the plurality of transport rollers has already started, in a case where the size sensor detects that a size of the document is about to be changed.

13. The document transport device according to claim 8, wherein
the one or more controllers control the document feed roller in such a way as to stop further supply of the document on the document feed tray to the transport path by the document feed roller, in a case where the size sensor detects that a size of the document is about to be changed.

14. The document transport device according to claim 8, further comprising:
an operation acceptor that transmits, to the one or more controllers, a command signal capable of specifying a job, based on a user's operation, wherein
the one or more controllers stop execution of the job specified by the command signal received from the operation acceptor, in a case where the size sensor detects that a size of the document is about to be changed.
